(19) United States
(12) Patent Application Publication
(10) Pub. No.: US 2004/0158701 A1
(43) Pub. Date: Aug. 12, 2004

(54) Method of decreasing boot up time in a computer system

(75) Inventor: Cynthia M. Merkin, Georgetown, TX (US)

Correspondence Address: BAKER BOTTS, LLP, 910 LOUISIANA, HOUSTON, TX, 77002-4995, US

(73) Assignee: Dell Products L.P., Round Rock, TX

(21) Appl. No.: 10/365,174

(22) Filed: Feb. 12, 2003

(51) Int. Cl. G06F 9/445

(52) U.S. Cl. 713/2

(57) ABSTRACT

A method of decreasing boot up time in a computer system is disclosed. The method may include initiating a basic input/output system (BIOS) boot process in the computer system. The method determines a total amount of memory installed in the computer system and divides the total amount of memory into a first memory group and a second memory group based on a system policy that sets a size of the first memory group. The method initializes the first memory group in the computer system such that the first memory group includes sufficient memory to load an operating system. The method loads an operating system on the computer system. In response to loading the operating system on the computer system, the method causes a plurality of system management interrupts (SMI) to occur whereby a portion of the second memory group is initialized during each of the SMI.

### TECHNICAL FIELD

This disclosure relates in general to the field of computers, and more particularly to a method of decreasing boot up time in a computer system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One type of information handling system is a computer system. Examples of the computer system include, but are not limited to, mainframes, workstations, servers, personal computers, notebook computers, laptop computers, and personal digital assistants (PDA). Each computer system may include a processor, memory, and storage media such as a hard drive.

As consumer demand has increased for faster more powerful computer systems, manufacturers strive to implement new methods to meet these demands. One of the new methods includes placing additional memory in the computer system. The additional memory, typically in the form of volatile memory such as random access memory (RAM), allows the computer system to perform several computing tasks in a shorter amount of time.

The additional memory, however, needs to be initialized each time the computer system is started or booted up. The initialization of all the computer memory causes a delay in time before an operating system and/or any computer applications may be loaded on the computer system. Hence, the additional memory in a computer system delays a user from using the computer system each time the computer system is booted up. In addition, the delay may be increased if the memory is tested during the initialization process.

### SUMMARY

Thus, a need has arisen for a system and method of decreasing the boot up time in a computer system.

A further need has arisen for a system and method of decreasing the boot up time in a computer system while testing the memory.

In accordance with the teachings of the present invention, the disadvantages and problems associated with a method for decreasing boot up time in a computer system have been substantially reduced or eliminated. In some embodiments of the present disclosure a method of booting up a computer system includes initiating a basic input/output system (BIOS) boot process in the computer system. The method determines a total amount of memory installed in the computer system and divides the total amount of memory into a first memory group and a second memory group based on a system policy that sets a size of the first memory group. The method initializes the first memory group in the computer system such that the first memory group includes sufficient memory to load an operating system on the computer system. The method loads an operating system on the computer system. In response to loading the operating system on the computer system, the method causes a plurality of system management interrupts (SMI) to occur whereby a portion of the second memory group is initialized during each of the SMI.

In another embodiment, a computer-readable medium having computer-executable instructions for performing a method includes determining a minimum memory size to load on a computer system such that the minimum memory size permits the computer system to load an operating system and a sub-set of computer applications. The method initiates in the computer system a basic input/output system (BIOS) boot process that includes a power-on self test (POST). In response to the BIOS boot process, the method determines a total amount of memory in the computer system such that the total amount of memory is divided into a first memory group and a second memory group, wherein the first memory group is equal to or greater than the minimum amount of memory. The method initializes the first memory group in the computer system, such that the first memory group is available to the computer system, and loads the operating system and the sub-set of computer system applications on the computer system. In response to the loading of the operating system and the sub-set of computer system applications, the method causes a plurality of system management interrupt (SMI) such that a portion of the second memory group is initialized during each SMI.

In further embodiments, an information handling system includes a processor and a memory communicatively coupled to the processor. A computer-readable medium having computer-executable instructions for performing a method, the method includes initiating a basic input/output system (BIOS) boot process in the information handling system. The method determines a total amount of the memory installed in the information handling system and separates the memory into a first memory group and a second memory group based on a minimum memory size. The method initializes the first memory group such that the first memory group is available for use by the information handling system. The method loads an operating system on the information handling system using the first memory group. In response to the loading of the operating system, the method causes a plurality of system management interrupts (SMI) with the BIOS boot process such that a portion of the second memory group is initialized during each SMI.

The present disclosure contains a number of important technical advantages. One technical advantage is providing a system and method of decreasing the boot up time in a computer system. Because initializing large amounts of computer memory delays the boot up process of a computer system, deferring the initialization of some of the memory decreases the boot up time of the computer system. After determining the total memory in the computer system, the method divides the memory into two group such that a first memory group is initialized and used to boot up the computer system. The remaining memory, or second memory group, may be initialized during system management interrupts (SMI). Thus, the boot up time of the computer system will be decreased.

Another technical advantage is providing a system and method of decreasing the boot up time in a computer system while testing the memory. Testing of each memory module, typically, may be performed in addition to initialization of the memory. Testing usually takes significantly longer since each part of the memory is reviewed for a potential problem. Despite the significant increase in time, computer system administrators routinely perform the test on the memory. Thus, a first memory group is initialized and tested, and made available to the computer system for loading an operating system. Meanwhile, the remaining memory may be initialized and tested during SMI events. Thus, the boot time of the computer system may be decreased while allowing for testing of all the computer memory.

All, some, or none of these technical advantages may be present in various embodiments of the present invention. Other technical advantages will be apparent to one skilled in the art from the following figures, descriptions, and claims.

### BRIEF DESCRIPTION OF THE DRAWINGS

A more complete understanding of the embodiments of the present disclosure and advantages thereof may be acquired by referring to the following description taken in conjunction with the accompanying drawings, in which like reference numbers indicate like features, and wherein:

FIG. 1 is a schematic representation of a computer system;

FIG. 2 illustrates a flowchart for a method of booting up a computer system according to an example embodiment of the present disclosure; and

FIG. 3 illustrates a flowchart for storing memory addresses in a computer system according to an example embodiment of the present disclosure.

### DETAILED DESCRIPTION

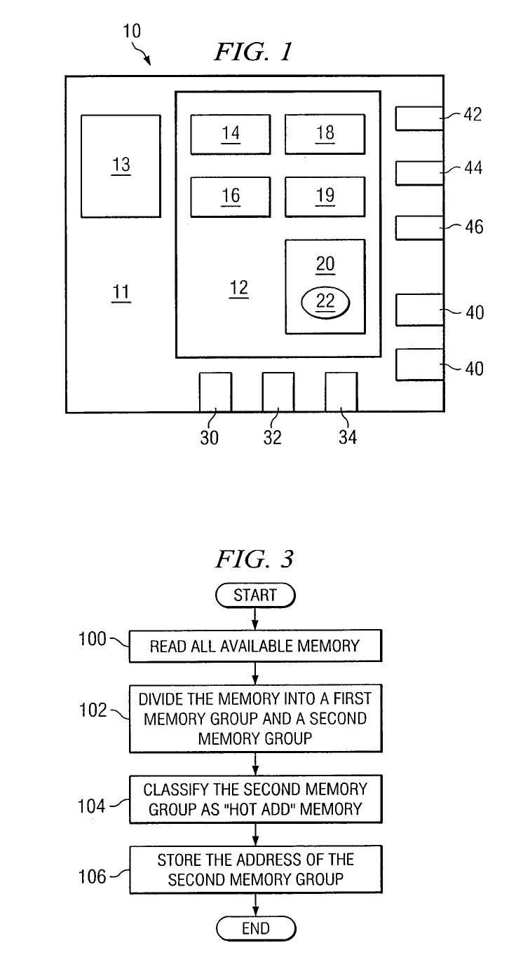

Preferred embodiments of the present disclosure and their advantages are best understood by reference to FIGS. 1 through 3, where like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices, as well as various input and output (I/O) devices, such as a keyboard, a mouse, and a video display. The information handling system may also include one or more buses operable to transmit communications between the various hardware components.

FIG. 1 is a schematic representation of computer system 10. Computer system 10 is one example of an information handling system that may include chassis 11. Generally, chassis 11 provides a housing for computer components coupled to computer system 10 and includes power supply 13 to power up the computer components associated with computer system 10. The computer components may be placed inside of chassis 11, or in some instances, mounted on the surface of chassis 11.

Motherboard 12 is placed inside of chassis 11 and serves as the main printed circuit board (PCB) for computer system 10. Because motherboard 12 is the main PCB for computer system 10, the computer components are generally interconnected to motherboard 12 via connectors, cables, or buses. Typically, motherboard 12 includes processor 14, memory 16, basic input/output system (BIOS) 18, and a complementary metal oxide semiconductor (CMOS) chip 20.

Processor 12, also known as a microprocessor, provides the computing power for computer system 10. Based on the computing power of processor 12, computer system 10 may be able to quickly perform large amounts of instructions received from the computer components. Typically, processor 12 receives instructions from computer components to perform arithmetic and logic operations.

Memory 16 may also be place on motherboard 12. However, in some instances, memory 16 is mounted on a riser card, or daughter card, that attached to motherboard 12 via a connector. Memory 16 provides computer system 10 with electronic storage for instructions and data that is quickly and easily accessible by processor 14. For instance, memory 16 may store data, instructions for certain program applications, and an operating system for computer system 10 to access and use while running.

One type of memory 16 is random access memory (RAM). RAM is volatile memory storage for computer system 10 that is erased each time power is removed from the RAM, hence the volatility. Having large amounts of RAM on computer system 10 allows the operating system to quickly store and access instructions/data for processor 14, as opposed to retrieving the data from a disk drive. Thus, computer system 10 is able perform instructions at a faster rate.

At a minimum, computer system 10 includes sufficient memory 16, generally RAM, to load the operating system. The operating system controls and directs the flow of information within computer system 10. Typically, computer system 10 includes sufficient RAM to load the operating system and a subset of certain applications, as well as, sufficient memory space to store much more instructions and data. In one example, memory 16 installed in computer systems 10 may be as little as sixteen megabites (MB) for smaller personal computer systems. However, for larger server applications, computer system 10 includes memory 16 ranging from four gigabites (GB) to 64 GB of storage.

Memory 16, specifically RAM, is different from physical storage devices, such as hard disk drives 30, CD-ROM drives 32, floppy disk drives 32 and tape drive systems, in that any information stored in RAM is lost upon removal of power. Information stored in the physical storage devices, however, is retained even with the power source removed from the devices. But storing and retrieving information from the physical storage devices by the operating system is considerably slower. In addition to losing information when power is removed, RAM is initialized each time computer system 10 is turned on. In some instances, RAM may be initialized and tested during a booting up process.

Other types of memory 16 include read-only memory (ROM) and electrically erasable programmable ROM (EEPROM). These types of memory 16 typically contain computer code in the form of instructions and data used to boot up computer system 10. For example, the BIOS boot program may be stored in ROM for access upon turning on computer system 10.

When computer system 10 is turned on, processor 14 may activate a BIOS boot process that performs instructions such as a power-on self-test (POST). Instructions for the POST may e stored in the BIOS or may stored on a physical storage device (e.g., a hard disk drive) with the address for the POST stored in the BIOS. Typically, the POST sends information to each computer component associated with computer system 10 to ensure each associate computer device is functioning properly. For example, the POST may send out a signal on a bus to determine which input/output (I/O) devices, such as keyboard 42, monitor 44, mouse 46, or other I/O devices attached to chassis 11 at I/O ports 40, are accessible by computer system 10. In addition to checking computer devices, the POST performs a memory check of all memory 16 placed in computer system 10. The memory check may include initialization, and possibly testing, of the memory 16.

Following the POST, the results of the POST are compared to information stored in CMOS chip 20. If the POST returns results that are different from the information stored in CMOS chip 20, BIOS 18 may request a user to update or reconfigure the information stored in CMOS chip 20.

Although CMOS chip 20 is generally placed on motherboard 12, CMOS chip 20 may also be located within chassis 11 and connected to motherboard 12 via cables or connectors, in which the stored information is compared with the results from the POST. The stored information typically includes the time, date, and computer system setup parameters. To prevent CMOS chip 20 from losing the stored information in the chip, CMOS battery 22 provides CMOS chip 20 with power whenever computer system 10 is turned off.

Anther function of BIOS 18 includes providing system management interrupts (SMI). Each SMI operates to temporarily halt the current instructions being performed in processor 14 to perform a different set of instructions. During a SMI, processor 14 determines the new set of instructions by reference to an interrupt table. The interrupt table stores the memory address for the new instructions, which directs processor 14 to begin performing the new instructions. In some instances, the SMI occurs at set intervals, such as a tick interval (e.g., a clock tick that is based on the speed of the system clock). Other SMI may be set to occur at the detection of specific events.

During the BIOS boot process, memory 16, specifically the RAM, is initialized and, possibly tested prior to loading an operating system in the RAM. Because the size of the RAM memory may be quite large, the initialization of memory 16 can take several seconds or even minutes depending upon the amount of memory placed in computer system 10. However, by initializing only a minimum amount of memory that allows the operating system to load, the boot up time of computer system 10 may be decreased.

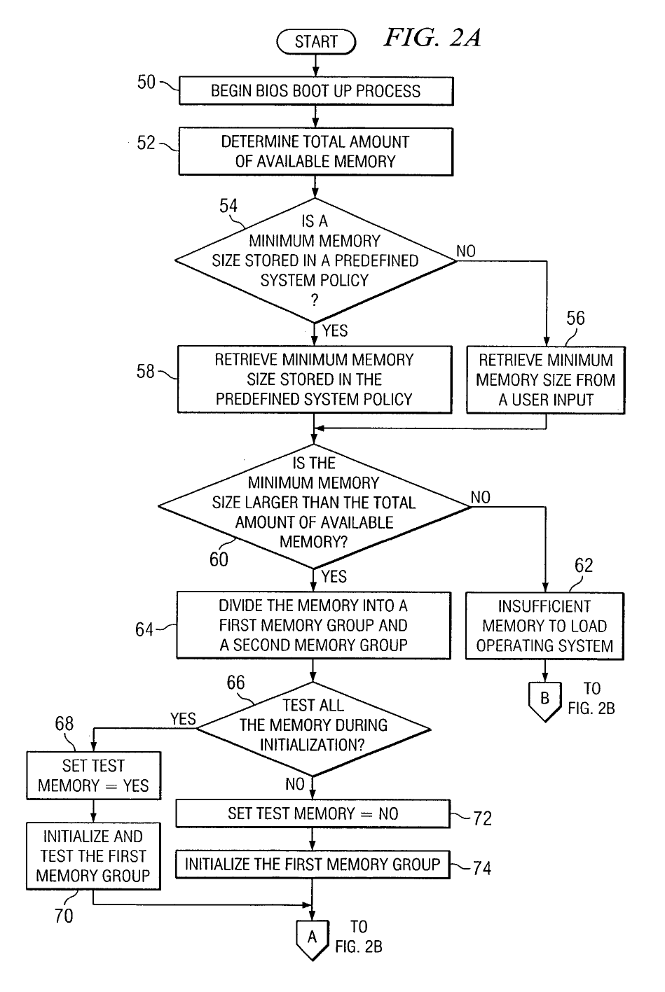

FIG. 2 illustrates a flowchart for a method of booting up computer system 10. At block 50, computer system 10 is turned on, or started up, to initiate a BIOS boot up process. Although the BIOS boot up process is generally known to initiate when power to computer system 10 is turned on, the BIOS boot up process may also be initiated during a restart of the computer system 10, when activating computer system 10 from a “sleep” state, or any other similar activity which causes the BIOS boot process to begin.

During the BIOS boot up process, instructions stored on a computer-readable medium may be performed to determine a total amount of available memory in computer system 10, at block 52. Computer-readable medium includes various types of computer memory such as floppy disks, optical disks including CD-ROMs, hard disks, EPROMs, Flash ROMs, nonvolatile memory including ROM, and RAM. The total amount of available memory may include RAM memory or any other memory 16 that may store instructions or data for an operating system. For example, RAM memory includes single in-line memory module (SIMM), dual in-line memory modules (DIMM), synchrous dynamic RAM (SDRAM) DIMM and several other types of memory 16.

In one particular embodiment, memory 16 is an SDRAM DIMM that includes a serial presence detect (SPD). The SPD is an EEPROM chip included on the memory module that stores and relates information about the module to BIOS 18, which is similar to older memory modules that use parallel presence detect (PPD). The information in the SPD enables BIOS 18 to determine the module's size, data width, speed and voltage. Thus, BIOS 18 may be able to determine a total amount of memory installed in computer system 10.

At block 54, the method determines whether a predefined system policy has been stored in computer system 10. The predefined system policy includes both hard-coded and computer-readable medium instructions that stores information on a minimum amount of memory needed to load an operating system into memory 16. Additionally, the predefined system policy may be varied to include additional memory allotments for loading subsets of certain applications into memory 16.

If a predefined system policy is not stored in computer system 10, BIOS 18 may halt the boot up process to request user input, at block 56. Depending upon the instructions in BIOS 18, the boot up process may be include a default value of all available memory if no input from a user is received with a particular time frame. Typically, the user is prompted via a setup screen to enter the minimum amount of memory for computer system 10. If a predefined system policy has been provided in BIOS 18, the BIOS boot up process retrieves the minimum amount of memory at block 58. In one example embodiment, a predefined system policy is set at the larger of the first memory module or four GB.

At block 60, a determination is made whether there is sufficient memory 16 installed in computer system 10 such that the total amount of available memory is larger than to the minimum amount of memory. If the minimum amount of available memory happens to be larger than the total amount of available memory, computer system 10 may determine that there is insufficient memory to load the operating system at block 62. Thus, to prevent computer system 10 from “freezing up,” or stop functioning, when the operating system was loaded with insufficient memory, BIOS 18 may send an error message and stop the boot up process, which causes the method to end.

Generally, computer system 10 includes ample memory 16, wherein memory 16 is divided into a first memory group and a second memory group at block 64. The first memory group includes that memory 16 which is equal to, or in some instances greater than, the minimum memory size as defined in the predefined system policy. The second memory group includes the remaining memory above the minimum amount of memory. For example, computer system 10 includes sixty-four GB of total available memory having a predefined system policy set for a minimum memory size of four GB. The, memory 16 would be divided into a first memory group having four GB and a second memory group of sixty GB.

At block 66, a determination is made as to whether memory 16 will be tested in addition to being initialized. Typically, the determination is stored in BIOS 18 whether memory 16 will be tested each time computer system is booted up. However, the determination may also be made by requesting user input in a setup screen.

If memory 16 is to be tested and initialized, instructions in the BIOS boot up process may set a variable, or bit, to a “yes” or true value at block 68. At block 70, the first memory group may be initialized and tested. If memory 16 is only to be initialized during the boot up process, the bit may be set to a “no” or false value at block 72. Thus, the first memory group is initialized at block 74.

At block 76, the BIOS boot up process begins to load an operating system into the first memory group. When loading the operating system in a typical boot up process, BIOS 18 first looks for a diskette in floppy disk drive 32 to load the operating system. In most cases, the operating system is located on hard disk drive 30, where the BIOS boot up process will look after not finding the operating system in floppy disk drive 32. After locating the operating system on hard disk drive 30, BIOS 18 typically accesses a boot record, or a master boot record, which contains the address locations of the operating system on the hard drive.

Loading, or booting up, the operating system into the first memory group is different than installing the operating system. Installing the operating system is generally the process of storing or writing the instructions onto the hard disk to initially install the program in computer system 10. Loading generally refers to access or copying the installed instructions to a location in memory 16 whereby processor 14 may readily access the instructions.

Generally, when loading the operating system into the first memory group, the BIOS boot up process first copies the initial system files. The initial system file is used to load the remaining instructions of the operating system such as the system files and the system configuration file. These files allow BIOS 18 to interact with computer system 10 while running and provide specific information on certain applications or programs that may need a device driver to operate with computer system 10.

In addition to loading the operating system, subsets of certain applications may also be loaded into the first memory group. The subset of certain applications generally includes an application program interface, which allows the operating system to communicate and interact with the application. Examples of applications that may be loaded into the first memory group include word processors, database programs, and any other suitable program.

After the operating system has started to load, BIOS 18 may perform or cause a plurality of system management interrupts (SMI) to occur in computer system 10 at block 78. During the SMI, a portion of the second memory group may be initialized, and possibly tested. Depending on the value of the test memory variable set in either block 68 or block 72, a determination whether to test the second group memory is made at block 80. If the test memory bit is true or “yes,” then a portion of the second memory group is tested and initialized during the SMI interval. However, if the value of test memory bit is false or “no,” then a portion of the second memory group is initialized at block 84.

At the end of the SMI, or end of the tick interval, the method determines whether the second memory group is finished initializing at block 86. Until all of the second memory group is initialized, and possibly tested, the method returns to block 78 where another SMI may occur to continue initializing portions of the second memory group. If the second memory group has finished initializing, BIOS 18 in a “hot add” memory procedure. makes the second memory group available for use by computer system 10.

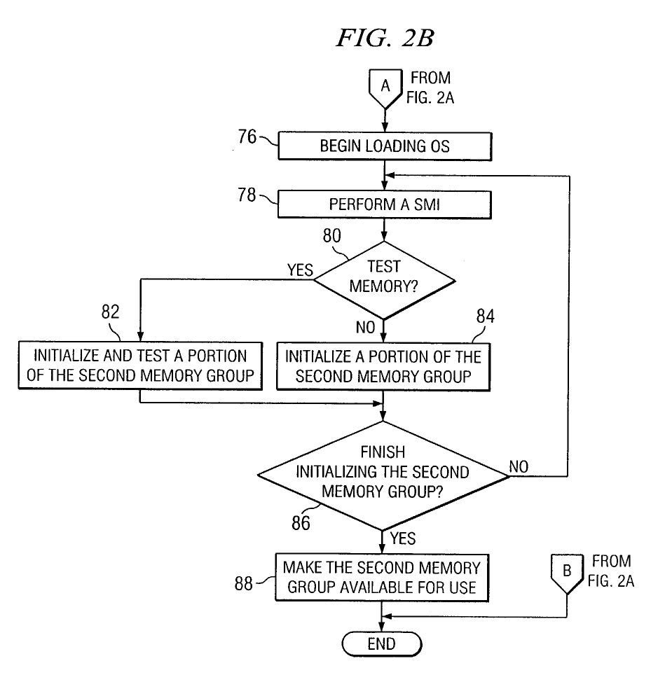

FIG. 3 illustrates a flowchart for storing memory addresses in computer system 10. Despite the fact that memory 16 may already be installed in computer system 10, the partitioned memory, namely the first memory group and the second memory group, may not be recognized by computer system 10.

During the BIOS boot up process, each memory 16, or memory module, may be read and identified to determine the total amount of available memory in computer system 10 at block 100. As previously described, a SPD on each memory 16 may be read to provide information about each memory 16 in computer system 10.

At block 102, the BIOS boot up process may divide the total amount of memory in computer system 10 into a first memory group and a second memory group. Because memory 16 is already installed in computer system 10, memory addresses may be stored in a static resource affinity table (SRAT). Although the first memory group will be made available prior to loading the operating system, computer system 10 may store information about the stored but not available memory 16.

Although the second memory group is described as one memory group, the second memory group may also be divided into smaller groups such as a third memory group and a fourth memory group. In certain embodiments, these additional memory groups may be initialized and made available to computer system 10 as a collective memory group or individually. Therefore, when the next additional memory group has finished initializing, that particular memory group may be made available to computer system 10, prior to initializing the next memory group.

At block 104, the BIOS boot up process may classify or label the second memory group as “hot add” memory in the SRAT. By classifying the second memory group as “hot add” memory, the operating system may be able to reserve space in memory where addition memory is located. In one example embodiment, the classification of memory 16 in a SRAT includes setting a bit in memory 16 to indicate that the second memory group is “hot add” memory.

By using an advanced configuration and power interface (ACPI) such as ACPI Specification 2.0 (hereby incorporated by reference in its entirety), BIOS 18 may include instructions that allow for memory 16 to be added to a running operating system without rebooting computer system 10. A specification for “hot add” of memory to an operating system is described in the “Hot-Add Memory Support in Windows.NET Server available from MICROSOFT, which is hereby incorporated by reference in its entirety.

At block 106, a memory address of the second memory group is stored. As previously described, the memory address for the second memory group may be placed (e.g., stored and written) in a SRAT. The operating system may use the SRAT to identify the second memory group following initialization because the address for the second memory group was reserved in the SRAT.

Although the present disclosure has been described with respect to a specific embodiment, various changes and modifications will be readily apparent to one skilled in the art. The present disclosure is not limited to the illustrated embodiment, but encompasses such changes and modifications that fall within the scope of the appended claims.

What is claimed is:

1. A method of booting up a computer system, the method comprising:
initiating a basic input/output system (BIOS) boot process in the computer system;
determining a total amount of memory installed in the computer system;
dividing the total amount of memory into a first memory group and a second memory group based on a system policy that sets a size of the first memory group;
initializing the first memory group in the computer system such that the first memory group includes sufficient memory to load an operating system on the computer system;
loading an operating system on the computer system; and
in response to loading the operating system on the computer system, causing a plurality of system management interrupts (SMI) to occur whereby a portion of the second memory group is initialized during each of the SMI.

2. The method of claim 1 wherein the initializing the second memory group of memory further comprises initializing the second memory group through the series of SMI after the operating system has booted up.

3. The method of claim 1 further comprising creating a memory topology in a static resource affinity table (SRAT) such that the second memory group is recognized by the computer system.

4. The method of claim 3 wherein the second memory group is classified as “hot-add” memory.

5. The method of claim 1 wherein the system policy comprises a pre-defined system policy such that the size of the first memory group is stored in the computer system.

6. The method of claim 1 further comprising receiving the system policy based on user input that sets the size of the first memory group.

7. The method of claim 1 further comprising notifying the computer system that the second memory group is initialized and available to the computer system.

8. The method of claim 1 further comprising setting the SMI to occur at periodic intervals.

9. A computer-readable medium having computer-executable instructions for performing a method comprising:
determining a minimum memory size to load on a computer system such that the minimum memory size permits the computer system to load an operating system and a sub-set of computer applications;
initiating a basic input/output system (BIOS) boot process in the computer system, the BIOS boot process including a power on self test (POST);
in response to the BIOS boot process, determining a total amount of memory in the computer system such that the total amount of memory is divided into a first memory group and a second memory group, wherein the first memory group is equal to or greater than the minimum amount of memory;
initializing the first memory group in the computer system such that the first memory group is available to the computer system;
loading the operating system and the sub-set of computer system applications on the computer system; and
in response to the loading of the operating system and the sub-set of computer system applications, causing a plurality of system management interrupt (SMI) such that a portion of the second memory group is initialized during each SMI.

10. The method of claim 9 further comprising allowing the computer system to access the second memory group after the second memory group is initialized.

11. The method of claim 9 wherein the initializing the first memory group further comprises performing a test on the first memory group.

12. The method of claim 9 further comprising performing a test on the second memory group during the SMI.

13. The method of claim 9 wherein determining the total amount of memory in the computer system comprises receiving information during the BIOS boot process from a serial presence detect (SPD) on the memory to determine the size of each memory module installed in the computer system.

14. An information handling system comprising:
a processor;
a memory communicatively coupled to the processor; and
a computer-readable medium having computer-executable instructions for performing a method, the method including:
initiating a basic input/output system (BIOS) boot process in the information handling system;
determining a total amount of the memory installed in the information handling system;
separating the memory into a first memory group and a second memory group based on a minimum memory size;
initializing the first memory group such that the first memory group is available for use by the information handling system;
loading an operating system on the information handling system using the first memory group; and
in response to the loading of the operating system, causing a plurality of system management interrupts (SMI) with the BIOS boot process such that a portion of the second memory group is initialized during each SMI.

15. The information handling system of claim 14 wherein the computer-readable medium having computer-executable instructions for performing instructions further comprises receiving information on the minimum memory size from user input.

16. The information handling system of claim 14 wherein the computer-readable medium having computer-executable instructions for performing instructions further comprises retrieving information on the minimum memory size from a pre-defined system policy stored in the information handling system.

17. The information handling system of claim 14 wherein the minimum memory size comprises four gigabits of memory.

18. The information handling system of claim 14 wherein the first memory group comprises a memory module.

19. The information handling system of claim 14 wherein the BIOS boot process is stored in non-volatile read only memory (ROM).

20. The information handling system of claim 14 wherein determining the total amount of memory further comprises receiving information stored in an electrically erasable programmable read only memory (EEPROM) chip associated with each memory in the information handling system.
